(19) United States
(12) Patent Application Publication
(10) Pub. No.: US 2017/0280133 A1
(43) Pub. Date: Sep. 28, 2017

(54) STEREO IMAGE RECORDING AND PLAYBACK

(71) Applicant: Nokia Technologies Oy, Espoo (FI)

(72) Inventors: Marko NIEMELÄ, Tampere (FI); Kim GRÖNHOLM, Helsinki (FI); Andrew BALDWIN, Tampere (FI)

(21) Appl. No.: 15/509,038

(22) PCT Filed: Sep. 9, 2014
(86) PCT No.: PCT/FI2014/050684

§ 371 Date: Mar. 6, 2017

(51) Int. Cl. H04N 13/02; G06T 15/04; H04N 13/00

(52) U.S. Cl. CPC H04N 13/0275; H04N 13/004; G06T 15/04

(57) ABSTRACT

The invention relates to forming a scene model and determining a first group of scene points, the first group of scene points being visible from a rendering viewpoint, determining a second group of scene points, the second group of scene points being at least partially obscured by the first group of scene points viewed from the rendering viewpoint, forming a first render layer using the first group of scene points and a second render layer using the second group of scene points, and providing the first and second render layers for rendering a stereo image. The invention also relates to receiving a first render layer and a second render layer comprising pixels, the first render layer comprising pixels corresponding to first parts of a scene viewed from a rendering viewpoint and the second render layer comprising pixels corresponding to second parts of the scene viewed from the rendering viewpoint, wherein the second parts of the scene are obscured by the first parts viewed from the rendering viewpoint, placing pixels of the first render layer and pixels of the second render layer in a rendering space,associating a depth value with the pixels, and rendering a stereo image using said pixels and said depth values.

### BACKGROUND

Digital stereo viewing of still and moving images has become commonplace, and equipment for viewing 3D (three-dimensional) movies is more widely available. Theatres are offering 3D movies based on viewing the movie with special glasses that ensure the viewing of different images for the left and right eye for each frame of the movie. The same approach has been brought to home use with 3D-capable players and television sets. In practice, the movie consists of two views to the same scene, one for the left eye and one for the right eye. These views have been created by capturing the movie with a special stereo camera that directly creates this content suitable for stereo viewing. When the views are presented to the two eyes, the human visual system creates a 3D view of the scene. This technology has the drawback that the viewing area (movie screen or television) only occupies part of the field of vision, and thus the experience of 3D view is limited.

For a more realistic experience, devices occupying a larger area of the total field of view have been created. There are available special stereo viewing goggles that are meant to be worn on the head so that they cover the eyes and display pictures for the left and right eye with a small screen and lens arrangement. Such technology has also the advantage that it can be used in a small space, and even while on the move, compared to fairly large TV sets commonly used for 3D viewing. For gaming purposes, there are games that are compatible with such stereo glasses, and are able to create the two images required for stereo viewing of the artificial game world, thus creating a 3D view of the internal model of the game scene. The different pictures are rendered in real time from the model, and therefore this approach requires computing power especially if the game's scene model is complex and very detailed and contains a lot of objects. This synthetic model based approach is not applicable for real-world video playback.

There is, therefore, a need for alternative solutions that enable stereo recording and playback, that is, capturing and viewing of 3D images such as 3D video.

### SUMMARY

Now there has been invented an improved method and technical equipment implementing the method, by which the above problems are alleviated. Various aspects of the invention include a method, an apparatus, a server, a renderer, a data structure and a computer readable medium comprising a computer program stored therein, which are characterized by what is stated in the independent claims. Various embodiments of the invention are disclosed in the dependent claims.

The invention relates to forming a scene model and determining a first group of scene points, the first group of scene points being visible from a rendering viewpoint, determining a second group of scene points, the second group of scene points being at least partially obscured by the first group of scene points viewed from the rendering viewpoint, forming a first render layer using the first group of scene points and a second render layer using the second group of scene points, and providing the first and second render layers for rendering a stereo image. The invention also relates to receiving a first render layer and a second render layer comprising pixels, the first render layer comprising pixels corresponding to first parts of a scene viewed from a rendering viewpoint and the second render layer comprising pixels corresponding to second parts of the scene viewed from the rendering viewpoint, wherein the second parts of the scene are obscured by the first parts viewed from the rendering viewpoint, placing pixels of the first render layer and pixels of the second render layer in a rendering space, associating a depth value with the pixels, and rendering a stereo image using said pixels and said depth values. The first render layer therefore comprises pixels that represent those parts of the scene that is directly visible from a viewpoint and have e.g. been captured by a first camera. The second render layer and further render layers comprise pixels that represent those parts of the scene that is obscured behind one or more objects. The data for the further render layers may have been captured by further cameras placed in different locations from the first camera.

According to a first aspect, there is provided a method, comprising forming a scene model using first image data from a first source image and second image data from a second source image, said scene model comprising scene points, each scene point having a location in a coordinate space of said scene, determining a first group of scene points, said first group of scene points being visible from a viewing point, said viewing point having a location in said coordinate space of said scene, determining a second group of scene points, said second group of scene points being at least partially obscured by said first group of scene points viewed from said viewing point, forming a first render layer using said first group of scene points and a second render layer using said second group of scene points, said first and second render layer comprising pixels, and providing said first and second render layers for rendering a stereo image.

According to an embodiment, the method comprises determining a third group of scene points, said third group of scene points being at least partially obstructed by said second group of scene points viewed from said viewing point, forming a third render layer using said third group of scene points, said third render layer comprising pixels, and providing said third render layer for rendering a stereo image. According to an embodiment, said second render layer is a sparse layer comprising active pixels corresponding to scene points at least partially obstructed by said first group of scene points. According to an embodiment, the method comprises forming dummy pixels in said second render layer, said dummy pixels not corresponding to scene points, and- encoding said second render layer into a data structure using an image encoder. According to an embodiment, the method comprises encoding said render layers into one or more encoded data structures using an image encoder. According to an embodiment, forming said scene model comprises determining a three-dimensional location for said scene points by utilizing depth information for said source images. According to an embodiment, forming said scene model comprises using camera position of said source images and comparing image contents of said source images. According to an embodiment, the method comprises forming one or more of said render layers to a two-dimensional image data structure, said image data structure comprising render layer pixels. According to an embodiment, render layer pixels comprise color values and a transparency value such as an alpha value. According to an embodiment, the method comprises forming data of at least two of said render layers into a collated image data structure, said collated image data structure comprising at least two segments, each segment corresponding to a respective render layer.

According to a second aspect, there is provided a method comprising receiving a first render layer and a second render layer, said first and second render layer comprising pixels, said first render layer comprising pixels corresponding to first parts of a scene viewed from a rendering viewpoint and said second render layer comprising pixels corresponding to second parts of said scene viewed from said rendering viewpoint, wherein said second parts of said scene are obscured by said first parts viewed from said rendering viewpoint, placing pixels of said first render layer and pixels of said second render layer in a rendering space, associating a depth value with said pixels, and rendering a left eye image and a right eye image using said pixels and said depth values.

According to an embodiment, said pixels of said first render layer and said second render layer comprise colour values and at least pixels of said first render layer comprise transparency values such as alpha values for rendering transparency of at least pixels of said first render layer. According to an embodiment, the method comprises determining whether a render layer to be rendered comprises semitransparent pixels, and in case said determining indicates a render layer comprises semitransparent pixels, enabling alpha blending in rendering of said render layer, otherwise disabling alpha blending in rendering said render layer. According to an embodiment, the method comprises receiving said first render layer and said second render layer from a data structure comprising pixel values as a two-dimensional image, determining colour values for said pixels of said first and second render layers by using texture mapping. According to an embodiment, the method comprises receiving said first render layer and said second render layer from a data structure comprising pixel values as a two-dimensional image, and determining depth values for said pixels of said first and second render layers by using texture mapping, said depth values indicating a distance from a rendering viewpoint. According to an embodiment, the method comprises receiving said first render layer and said second render layer from a data structure comprising pixel values as a two-dimensional image, and determining viewing angle values for said pixels of said first and second render layers by using texture mapping.

According to a third aspect, there is provided an apparatus for carrying out the method according to the first aspect and/or its embodiments.

According to a fourth aspect, there is provided an apparatus for carrying out the method according to the second aspect and/or its embodiments.

According to a fifth aspect, there is provided a system for carrying out the method according to the first aspect and/or its embodiments.

According to a sixth aspect, there is provided a system for carrying out the method according to the second aspect and/or its embodiments.

According to a seventh aspect, there is provided a computer program product for carrying out the method according to the first aspect and/or its embodiments.

According to a sixth aspect, there is provided a computer program product for carrying out the method according to the second aspect and/or its embodiments.

### DESCRIPTION OF THE DRAWINGS

In the following, various embodiments of the invention will be described in more detail with reference to the appended drawings, in which

FIGS. 1a, 1b, 1c and 1d show a setup for forming a stereo image to a user;

FIG. 2a shows a system and apparatuses for stereo viewing;

FIG. 2b shows a stereo camera device for stereo viewing;

FIG. 2c shows a head-mounted display for stereo viewing;

FIG. 2d illustrates a camera device;

FIG. 3a illustrates an arrangement for capturing images or video for 3D rendering;

FIG. 3b illustrates forming a point cloud from multiple captured images;

FIGS. 4a and 4b illustrate forming render layers and forming image data for storing;

FIG. 4c illustrates rendering images using render layers;

FIG. 5a is a flow chart of forming render layers by capturing image data;

FIG. 5b is a flow chart of rendering images using render layers;

FIGS. 6a and 6b depict data structures comprising render layers for rendering an image; and

FIG. 7 shows examples of render layers.

### DESCRIPTION OF EXAMPLE EMBODIMENTS

In the following, several embodiments of the invention will be described in the context of stereo viewing with 3D glasses. It is to be noted, however, that the invention is not limited to any specific display technology. In fact, the different embodiments have applications in any environment where stereo viewing is required, for example movies and television. Additionally, while the description may use a camera setup as an example of an image source, different camera setups and image source arrangements can be used. It needs to be understood that the features of various embodiments may appear alone or in combination. Thus, even though the different features and embodiments have been described one by one, their combination has inherently also been disclosed herein.

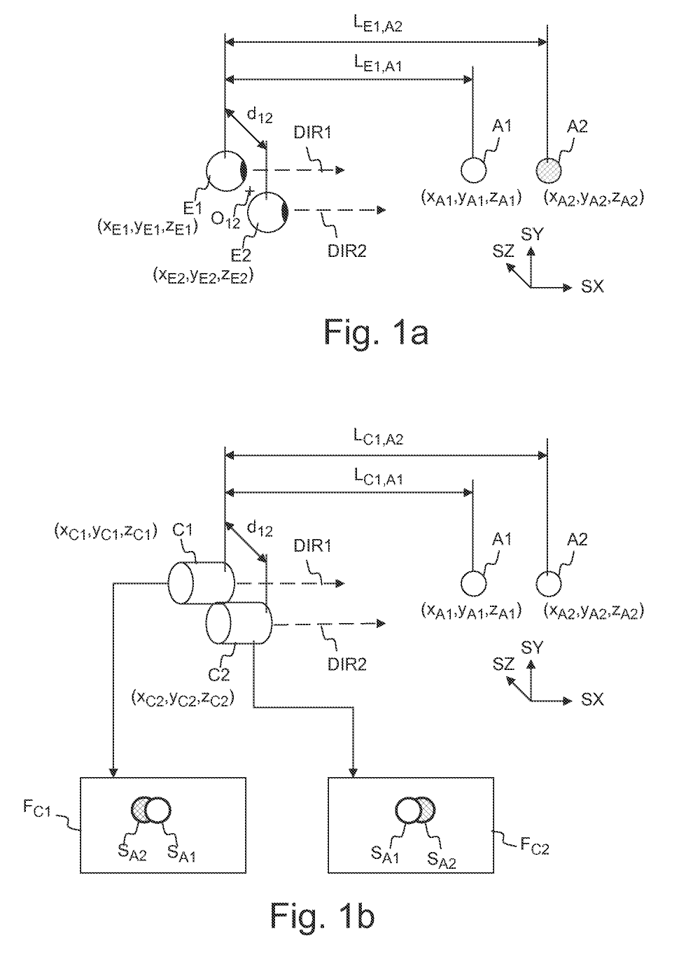

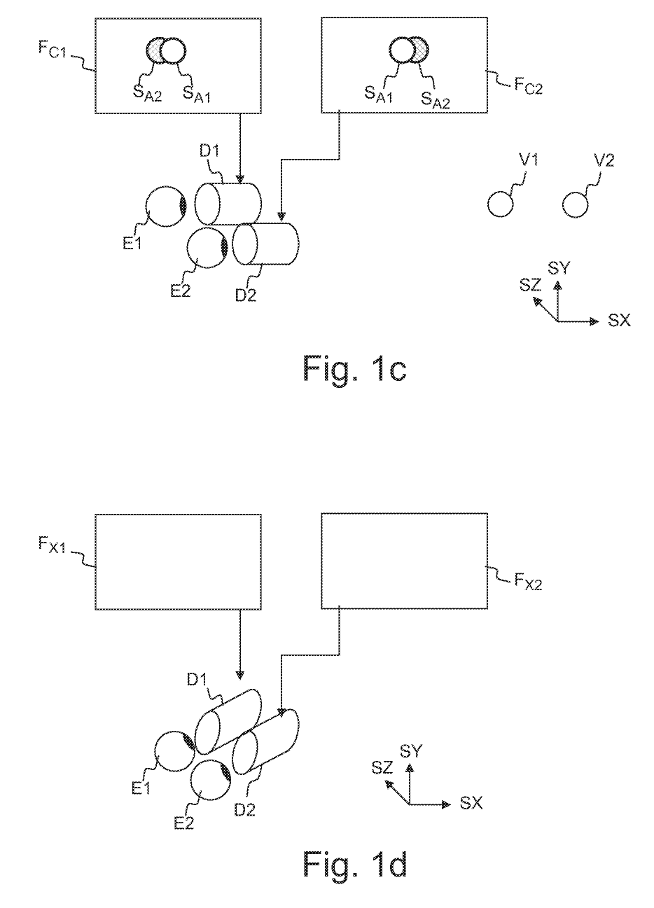

FIGS. 1a, 1b, 1c and 1d show a setup for forming a stereo image to a user. In FIG. 1a, a situation is shown where a human being is viewing two spheres A1 and A2 using both eyes E1 and E2. The sphere A1 is closer to the viewer than the sphere A2, the respective distances to the first eye E1 being L_{E1,A1} and L_{E1,A2}. The different objects reside in space at their respective (x,y,z) coordinates, defined by the coordinate system SZ, SY and SZ. The distance d₁₂ between the eyes of a human being may be approximately 62-64 mm on average, and varying from person to person between 55 and 74 mm. This distance is referred to as the parallax, on which stereoscopic view of the human vision is based on. The viewing directions (optical axes) DIR1 and DIR2 are typically essentially parallel, possibly having a small deviation from being parallel, and define the field of view for the eyes. The head of the user has an orientation (head orientation) in relation to the surroundings, most easily defined by the common direction of the eyes when the eyes are looking straight ahead. That is, the head orientation tells the yaw, pitch and roll of the head in respect of a coordinate system of the scene where the user is.

In the setup of FIG. 1a, the spheres A1 and A2 are in the field of view of both eyes. The center-point O₁₂ between the eyes and the spheres are on the same line. That is, from the center-point, the sphere A2 is obscured behind the sphere A1. However, each eye sees part of sphere A2 from behind A1, because the spheres are not on the same line of view from either of the eyes.

In FIG. 1b, there is a setup shown, where the eyes have been replaced by cameras C1 and C2, positioned at the location where the eyes were in FIG. 1a. The distances and directions of the setup are otherwise the same. Naturally, the purpose of the setup of FIG. 1b is to be able to take a stereo image of the spheres A1 and A2. The two images resulting from image capture are F_{C1} and F_{C2}. The “left eye” image F_{C1} shows the image S_{A2} of the sphere A2 partly visible on the left side of the image S_{A1} of the sphere A1. The “right eye” image F_{C2} shows the image S_{A2} of the sphere A2 partly visible on the right side of the image S_{A1} of the sphere A1. This difference between the right and left images is called disparity, and this disparity, being the basic mechanism with which the human visual system determines depth information and creates a 3D view of the scene, can be used to create an illusion of a 3D image.

In FIG. 1c, the creating of this 3D illusion is shown. The images F_{C1} and F_{C2} captured by the cameras C1 and C2 are displayed to the eyes E1 and E2, using displays D1 and D2, respectively. The disparity between the images is processed by the human visual system so that an understanding of depth is created. That is, when the left eye sees the image S_{A2} of the sphere A2 on the left side of the image S_{A1} of sphere A1, and respectively the right eye sees the image of A2 on the right side, the human visual system creates an understanding that there is a sphere V2 behind the sphere V1 in a three-dimensional world. Here, it needs to be understood that the images F_{C1} and F_{C2} can also be synthetic, that is, created by a computer. If they carry the disparity information, synthetic images will also be seen as three-dimensional by the human visual system. That is, a pair of computer-generated images can be formed so that they can be used as a stereo image.

FIG. 1d illustrates how the principle of displaying stereo images to the eyes can be used to create 3D movies or virtual reality scenes having an illusion of being three-dimensional. The images F_{X1} and F_{X2} are either captured with a stereo camera or computed from a model so that the images have the appropriate disparity. By displaying a large number (e.g. 30) frames per second to both eyes using display D1 and D2 so that the images between the left and the right eye have disparity, the human visual system will create a cognition of a moving, three-dimensional image. When the camera is turned, or the direction of view with which the synthetic images are computed is changed, the change in the images creates an illusion that the direction of view is changing, that is, the viewer is rotating. This direction of view, that is, the head orientation, may be determined as a real orientation of the head e.g. by an orientation detector mounted on the head, or as a virtual orientation determined by a control device such as a joystick or mouse that can be used to manipulate the direction of view without the user actually moving his head. That is, the term “head orientation” may be used to refer to the actual, physical orientation of the user's head and changes in the same, or it may be used to refer to the virtual direction of the user's view that is determined by a computer program or a computer input device.

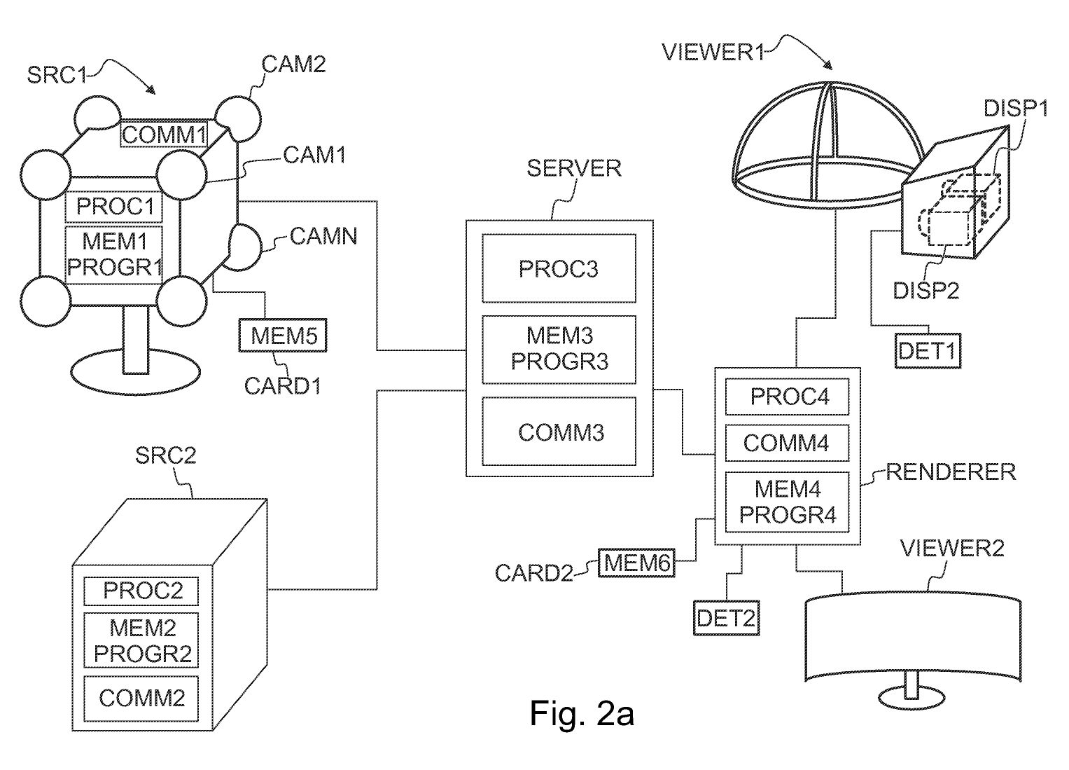

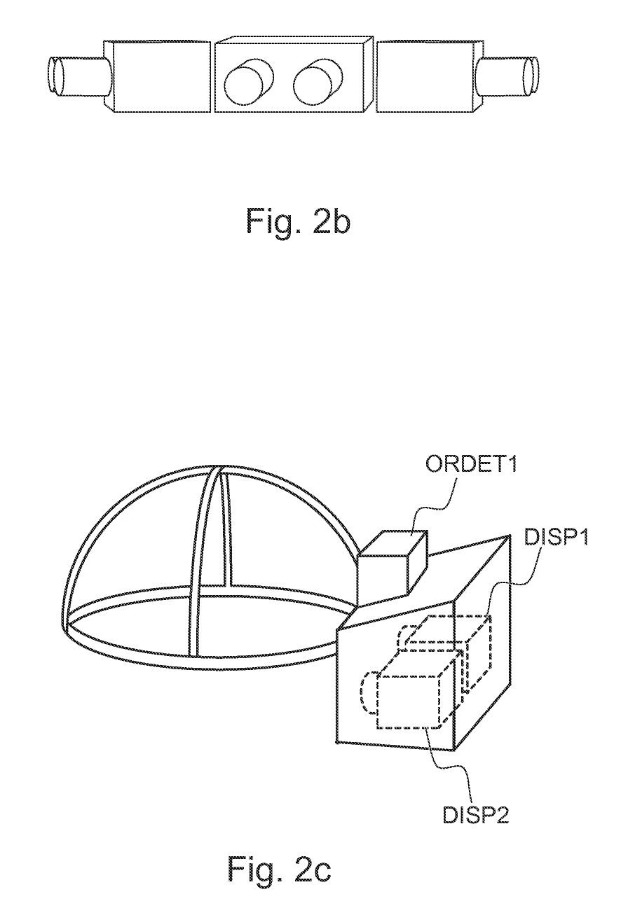

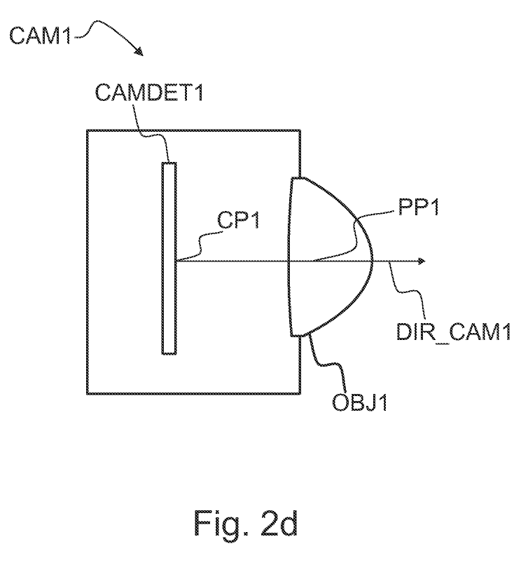

FIG. 2a shows a system and apparatuses for stereo viewing, that is, for 3D video and 3D audio digital capture and playback. The task of the system is that of capturing sufficient visual and auditory information such that a convincing reproduction of the experience, or presence, of being in that location can be achieved by one or more viewers physically located in different locations and optionally at a time later in the future. Such reproduction requires more information than can be captured by a single camera or microphone, in order that a viewer can determine the distance and location of objects within the scene using their eyes and their ears. As explained in the context of FIGS. 1a to 1d, to create a pair of images with disparity, two camera sources are used. In a similar manned, for the human auditory system to be able to sense the direction of sound, at least two microphones are used (the commonly known stereo sound is created by recording two audio channels). The human auditory system can detect the cues e.g. in timing difference of the audio signals to detect the direction of sound.

The system of FIG. 2a may consist of three main parts: image sources, a server and a rendering device. A video capture device SRC1 comprises multiple (for example, 8) cameras CAM1, CAM2, . . . , CAMN with overlapping field of view so that regions of the view around the video capture device is captured from at least two cameras. The device SRC1 may comprise multiple microphones to capture the timing and phase differences of audio originating from different directions. The device may comprise a high resolution orientation sensor so that the orientation (direction of view) of the plurality of cameras can be detected and recorded. The device SRC1 comprises or is functionally connected to a computer processor PROC1 and memory MEM1, the memory comprising computer program PROGR1 code for controlling the capture device. The image stream captured by the device may be stored on a memory device MEM2 for use in another device, e.g. a viewer, and/or transmitted to a server using a communication interface COMM1.

As explained above, a single camera device may comprise a plurality of cameras and/or a plurality of microphones. A plurality of camera devices placed at different locations may also be used, where single camera device may comprise one or more cameras. The camera devices and their cameras may in this manner be able to capture image data of the objects in the scene in a more comprehensive manner than a single camera device. For example, if there is a second object hidden behind a first object when the objects are viewed from a certain viewpoint of a first camera device or a first camera, the second object may be visible from another viewpoint of a second camera device or a second camera. Thus, image data of the second object may be gathered e.g. for producing a 3D view where a part of the second object is partially visible from behind the first object to one eye but not the other. To produce unified picture data from two or more cameras, the picture data from different cameras needs to be combined together. Also, the different objects in the scene may be determined by analyzing the data from different cameras. This may allow the determination of the three-dimensional location of objects in the scene.

Alternatively or in addition to the video capture device SRC1 creating an image stream, or a plurality of such, one or more sources SRC2 of synthetic images may be present in the system. Such sources of synthetic images may use a computer model of a virtual world to compute the various image streams it transmits. For example, the source SRC2 may compute N video streams corresponding to N virtual cameras located at a virtual viewing position. When such a synthetic set of video streams is used for viewing, the viewer may see a three-dimensional virtual world, as explained earlier for FIG. 1d. The device SRC2 comprises or is functionally connected to a computer processor PROC2 and memory MEM2, the memory comprising computer program PROGR2 code for controlling the synthetic source device SRC2. The image stream captured by the device may be stored on a memory device MEM5 (e.g. memory card CARD1) for use in another device, e.g. a viewer, or transmitted to a server or the viewer using a communication interface COMM2.

There may be a storage, processing and data stream serving network in addition to the capture device SRC1. For example, there may be a server SERV or a plurality of servers storing the output from the capture device SRC1 or computation device SRC2. The device comprises or is functionally connected to a computer processor PROC3 and memory MEM3, the memory comprising computer program PROGR3 code for controlling the server. The server may be connected by a wired or wireless network connection, or both, to sources SRC1 and/or SRC2, as well as the viewer devices VIEWER1 and VIEWER2 over the communication interface COMM3.

For viewing the captured or created video content, there may be one or more viewer devices VIEWER1 and VIEWER2. These devices may have a rendering module and a display module, or these functionalities may be combined in a single device. The devices may comprise or be functionally connected to a computer processor PROC4 and memory MEM4, the memory comprising computer program PROGR4 code for controlling the viewing devices. The viewer (playback) devices may consist of a data stream receiver for receiving a video data stream from a server and for decoding the video data stream. The data stream may be received over a network connection through communications interface COMM4, or from a memory device MEM6 like a memory card CARD2. The viewer devices may have a graphics processing unit for processing of the data to a suitable format for viewing as described with FIGS. 1c and 1d. The viewer VIEWER1 comprises a high-resolution stereo-image head-mounted display for viewing the rendered stereo video sequence. The head-mounted device may have an orientation sensor DET1 and stereo audio headphones. The viewer VIEWER2 comprises a display enabled with 3D technology (for displaying stereo video), and the rendering device may have a head-orientation detector DET2 connected to it. Any of the devices (SRC1, SRC2, SERVER, RENDERER, VIEWER1, VIEWER2) may be a computer or a portable computing device, or be connected to such. Such rendering devices may have computer program code for carrying out methods according to various examples described in this text.

FIG. 2b shows an example of camera device with multiple cameras for capturing image data for stereo viewing. The camera comprises two or more cameras that are configured into camera pairs for creating the left and right eye images, or that can be arranged to such pairs. The distance between cameras may correspond to the usual distance between the human eyes. The cameras may be arranged so that they have significant overlap in their field-of-view. For example, wide-angle lenses of 180 degrees or more may be used, and there may be 3, 4, 5, 6, 7, 8, 9, 10, 12, 16 or 20 cameras. The cameras may be regularly or irregularly spaced across the whole sphere of view, or they may cover only part of the whole sphere. For example, there may be three cameras arranged in a triangle and having a different directions of view towards one side of the triangle such that all three cameras cover an overlap area in the middle of the directions of view. As another example, 8 cameras having wide-angle lenses and arranged regularly at the corners of a virtual cube and covering the whole sphere such that the whole or essentially whole sphere is covered at all directions by at least 3 or 4 cameras. In FIG. 2b, three stereo camera pairs are shown. As explained earlier, a plurality of camera devices may be used to capture image data of the scene, the camera devices having one or more cameras. The camera devices may be such as shown in FIG. 2b that they are able to create stereoscopic images, or they may produce single-view video data. The data from different cameras—from the plurality of cameras of one camera device and/or the plurality of cameras of different camera devices—may be combined to obtain three-dimensional image data of a scene.

FIG. 2c shows a head-mounted display for stereo viewing. The head-mounted display contains two screen sections or two screens DISP1 and DISP2 for displaying the left and right eye images. The displays are close to the eyes, and therefore lenses are used to make the images easily viewable and for spreading the images to cover as much as possible of the eyes' field of view. The device is attached to the head of the user so that it stays in place even when the user turns his head. The device may have an orientation detecting module ORDET1 for determining the head movements and direction of the head. It is to be noted here that in this type of a device, tracking the head movement may be done, but since the displays cover a large area of the field of view, eye movement detection is not necessary. The head orientation may be related to real, physical orientation of the user's head, and it may be tracked by a sensor for determining the real orientation of the user's head. Alternatively or in addition, head orientation may be related to virtual orientation of the user's view direction, controlled by a computer program or by a computer input device such as a joystick. That is, the user may be able to change the determined head orientation with an input device, or a computer program may change the view direction (e.g. in a program may control the determined head orientation instead or in addition to the real head orientation).

FIG. 2d illustrates a camera device CAM1. The camera device has a camera detector CAMDET1, comprising a plurality of sensor elements for sensing intensity of the light hitting the sensor element. The camera device has a lens OBJ1 (or a lens arrangement of a plurality of lenses), the lens being positioned so that the light hitting the sensor elements travels through the lens to the sensor elements. The camera detector CAMDET1 has a nominal center point CP1 that is a middle point of the plurality sensor elements, for example for a rectangular sensor the crossing point of the diagonals. The lens has a nominal center point PP1, as well, lying for example on the axis of symmetry of the lens. The direction of orientation of the camera is defined by the half-line passing from the center point CP1 of the camera sensor and the center point PP1 of the lens.

The system described above may function as follows. Time-synchronized video, audio and orientation data is first recorded with the cameras of one or more camera devices. This can consist of multiple concurrent video and audio streams as described above. These are then transmitted immediately or later to the storage and processing network for processing and conversion into a format suitable for subsequent delivery to playback devices. The conversion can involve post-processing steps to the audio and video data in order to improve the quality and/or reduce the quantity of the data while preserving the quality ata desired level. Finally, each playback device receives a stream of the data from the network or from a storage device, and renders it into a stereo viewing reproduction of the original location which can be experienced by a user with the head mounted display and headphones.

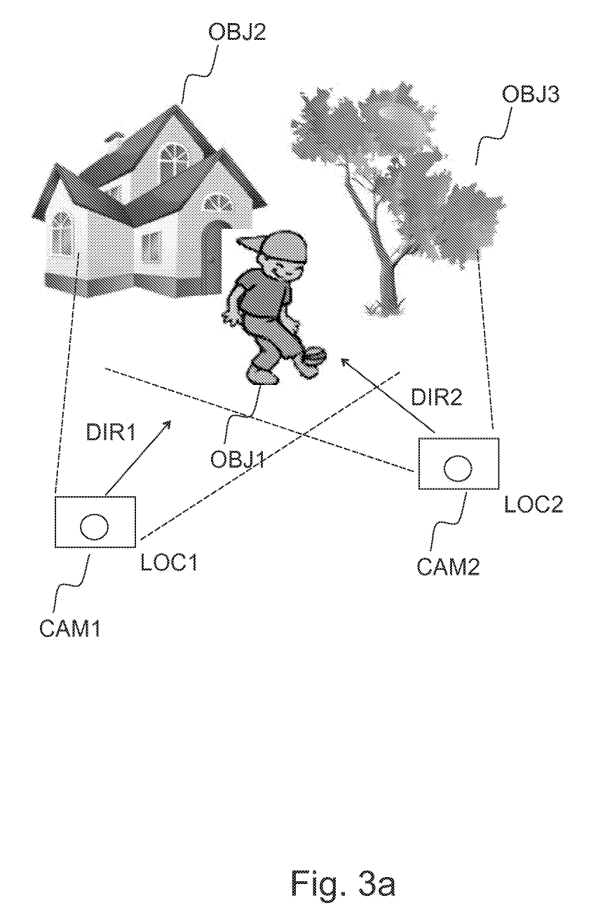

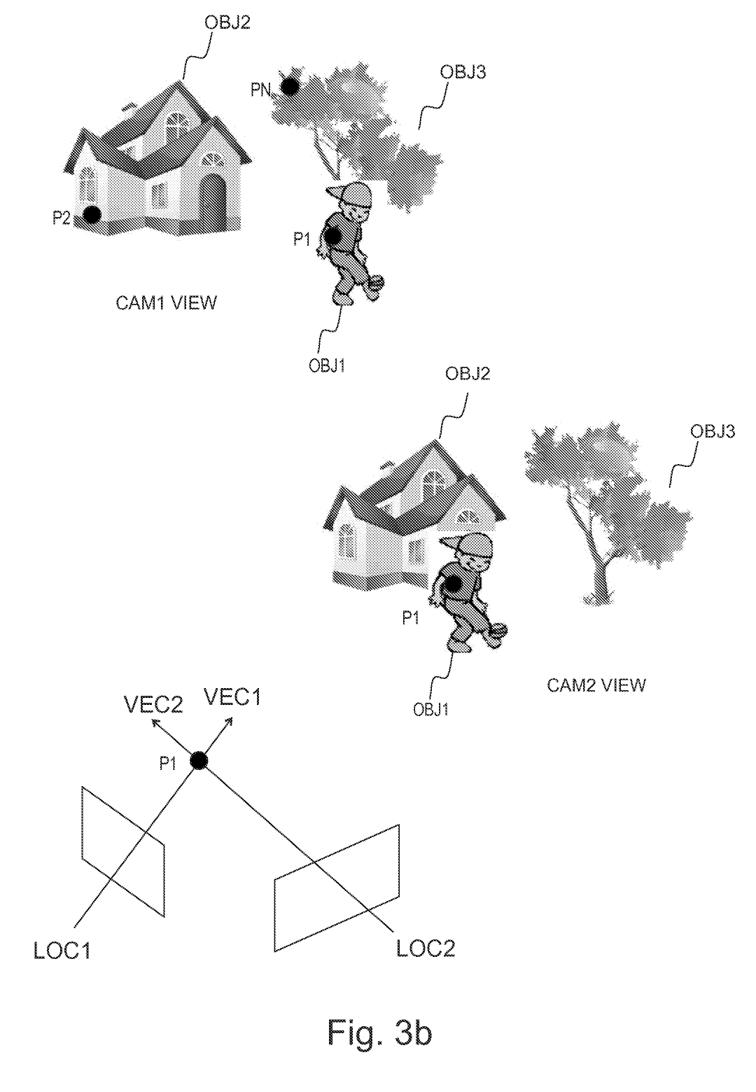

FIG. 3a illustrates an arrangement for capturing images or video for 3D rendering. There are two fundamental options for capturing image data for 3D rendering. The first option is to capture image data from real world using cameras. The second option is to generate the image data from a synthetic scene model. A combination of the first option and the second option may also be used, e.g. to place synthetic objects in real-world scene (animated movies) or vice versa (virtual reality). With either option or their combination, a number of cameras may be used to capture colour data of the objects in the scene. The location, orientation and optical characteristics (e.g. lens properties) of the cameras are known. This makes it possible to detect the presence of an object in multiple pictures, which in turn allows the determination of the position of the various objects (or their surface points) in the scene. When the locations and colours of the points of the surfaces of the objects are known, an image of the scene viewed from a render viewpoint can be generated. This will be explained later.

Image data may be captured from a real scene using multiple cameras at different locations. Pairs of cameras may be used to create estimates of depth for every point matching in both images. The point estimates are mapped into a common origin and orientation, and duplicate entries removed by comparing their colour and position values. The points are then arranged into render layers, or layers as a shorter expression, based on their order of visibility from a render viewpoint.

The top layer is typically not sparse, and contains an entry for every point of the scene viewed from the origin (the render viewpoint). Each obscured pixel is moved into a sparse subsidiary layer, with one or more sparse layers created as is necessary to store recorded data and to represent the view in sufficient detail. In addition, synthetic data can be generated into the sparse layers surrounding the recorded data in order to avoid later problems with visible holes when rendering.

The layers may be represented as two-dimensional images, the images having pixels, and the pixels having associated color and depth values. The layers may be mapped to the rendering space via a coordinate transformation and e.g. by using texture operations of a graphics processor to interpolate colour and depth values of the pixels.

Each moment in time may be encoded with a new set of layers and mapping parameters, to allow time-based playback of changes in the 3D environment. In each frame, new layer data and mapping metadata is taken into use for each new frame. Alternatively, time/based playback can be paused and a single frame can be used and rendered from different positions.

Alternatively, synthetic video sources in a virtual reality model may be used for creating images for stereo viewing. One or more virtual camera devices, possibly comprising a plurality of cameras, are positioned in the virtual world of the movie.The action taking place may be captured by the computer into video streams corresponding to the virtual cameras of the virtual camera device (corresponding to so-called multi-view video where a user may switch viewpoints). Alternatively, a single camera location may be used as the viewing point. In other words, the content delivered to a player may be generated synthetically in the same way as for a conventional 3D film, however including multiple camera views (more than 2), and multiple audio streams allowing a realistic audio signal to be created for each viewer orientation. In practical terms, the internal three-dimensional (moving) model of the virtual world is used to compute the image source images. Rendering the different objects result in an image captured by a camera, and the computations are carried out for each camera (one or more cameras). The virtual cameras do not obstruct each other in the same manner as real cameras, because virtual cameras can be made invisible in the virtual world. The image data for the render layers may be generated from a complex synthetic model (such as a CGI film content model) using processing by a graphics processor or a general purpose processor to render the world from a single viewpoint into the layer format, with an predetermined number of obscured pixels (a predetermined number of obscured pixel layers) being stored in subsidiary layers.

FIG. 3b illustrates forming a point cloud from multiple captured images. The image data may be captured from a real scene using a number of different techniques. If multiple images are available for the same scene, with each image captured from a different origin position, that image data can be used to estimate the position and colour for object surfaces. The exact positions (LOC1, LOC2) and orientations (DIR1, DIR2) of the cameras in the scene may be known or calculated for each image. In addition, the lens behavior may be known or calculated so that each pixel in the image has a direct correspondence with a 3d vector in space. With this information, pixels from one image (CAM VIEW 1) from a first camera can be matched against similar coloured pixels in anotherimage (CAM VIEW 2) from a second camera along the vector path upon which the matching pixel must lie. Once a match is found, the position (coordinates) in space can be found from the intersection point of the two 3d vectors (VEC1 and VEC2 for point P1). In this manner, points P1, P2, P3, . . . PN of the surfaces of the objects may be determined, that is, the colour and position of the points may be calculated.

At least 3 overlapping images are needed in order to estimate the position of some objects which are obscured in just one of the images by another object. This then gives 2 layers of information (first objects visible from the render viewpoint and objects hidden behind the first objects). For objects which are obscured in all but one image, rough position estimates can be made by extrapolating from the position of nearby similar known objects.

Multiple images may be captured at different times from different positions by the same camera. In this case the camera position will need to be measured using another sensor, or using information about the change in position of reference objects in the scene. In this case, objects in the scene should be static.

Alternatively, multiple images can be captured using multiple cameras simultaneously in time, each with a known or pre-calibrated relative position and orientation to a reference point. In this case objects in the scene, or the camera system itself, need not be static. With this approach it is possible to create sequences of layers for each moment in time matching the moments when each set of images was captured.

Another technique for creating point data for render layers is to use sensors employing a “time of flight” technique to measure the exact time taken for a pulse of light (from a laser or LED) to travel from the measuring device, off the object, and back to the measuring device. Such a sensor should be co-located and calibrated with a normal colour image sensor with the same calibration requirements as the multiple image technique, such that each pixel can be given an estimated colour and position in space relative to the camera. However, with only one pair of such sensors, only a single layer of data can be generated. At least two such pairs covering the same scene would be needed in order to generate two layers (to estimate positions for some objects obscured in the other pair). An additional pair may be used for each additional layer.

A related technique with similar restrictions is to use a “lidar” scanner in place of the time-of-flight sensor. This typically scans a laser beam over the scene and measures the phase or amplitude of the reflected light, to create an accurate estimate of distance. Again additional pairs of lidar+image sensors may be used to generate each additional layer.

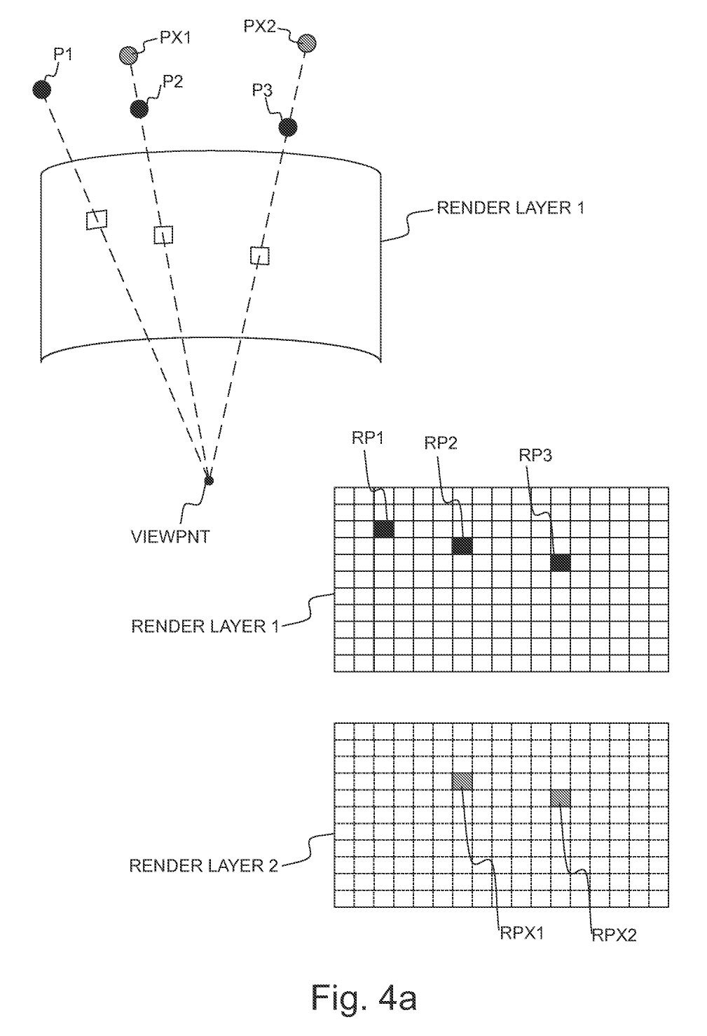

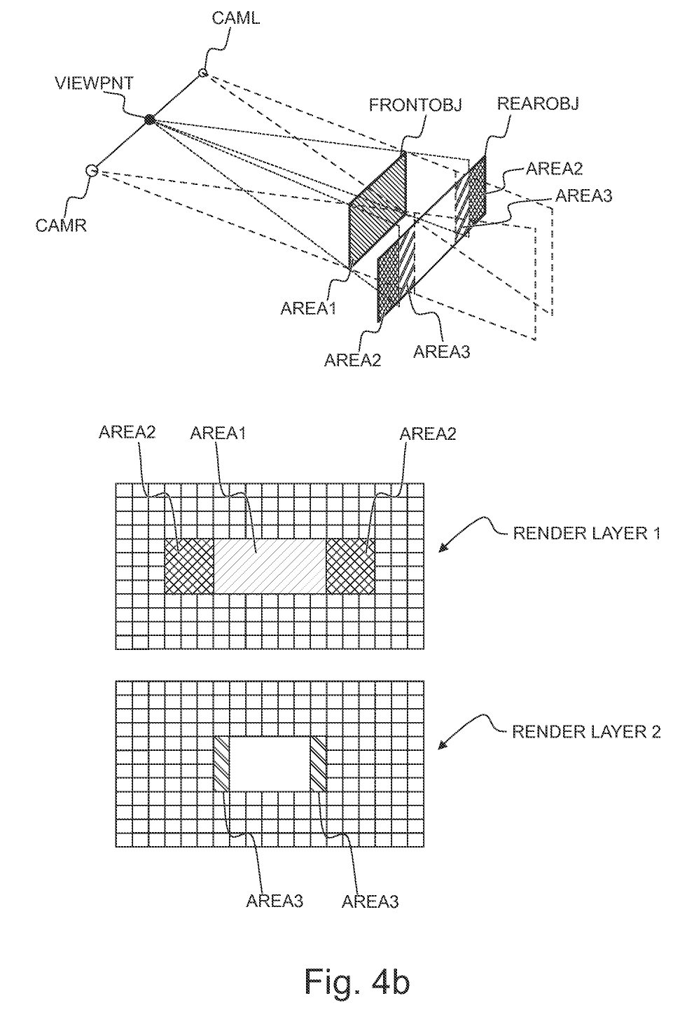

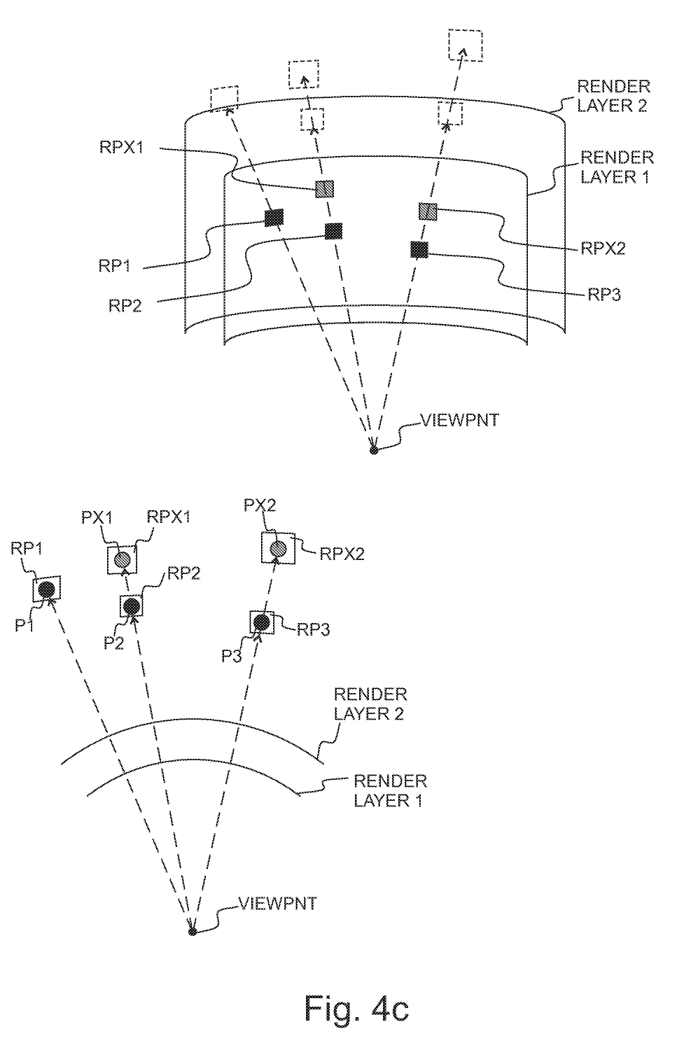

FIG. 4a illustrates forming render layers and forming image data for storing or transmission. A scene is recorded for storing into a file or for transmission by creating multiple sets of pixels, that is, render layers, with each data point in the layer including at least a vector from a common origin and colour data. Each data set may be compressed using known 2D image or video sequence compression techniques.

As explained earlier, a number of points P1, . . . , PN and PX1, PX2 in FIG. 4a may be formed, each point having colour and a position in space. Points PX1 and PX2 are hidden behind pixels P1, P2 and P3. These points are then converted to render layers so that a first render layer RENDER LAYER 1 is created from the directly visible points when viewing from a viewpoint VIEWPNT, and one or more render layers RENDER LAYER 2 are created at least partially from points that are hidden behind the first render layer. The position vector of each point may be stored or compressed in different ways. It can be simply expressed as 3 independent parameters per point—either a pair of angles and a distance from reference vector (a vector defined by a viewpoint and a view direction), or 3 distances in orthogonal axis direction. Alternatively, a parametrized mapping function can be used to more compactly encode the position vector for each point in space from the origin based upon the index of the point into a sequence of points, interpreted as a 2 dimensional regular layout (image) with known integer width and height, comprising render layer pixels RP1, RP2, RP3 and RPX1, RPX2. This corresponds to render layers RENDER LAYER 1 and RENDER LAYER 2 in FIG. 4a This may for example map x and y coordinates directly to yaw and pitch coordinates, allowing a full sphere to be encoded into a rectangular structure. Pixel colour values for each (yaw,pitch) pixel may be formed by interpolation from the existing point values. Alternatively a circular mapping function may be used such as an equisolid mapping [radius=2*focalLength*sin(angleFromAxis/2)] to map a hemisphere or more to a circular image.

Alternatively a circlular mapping function may be used to map the spherical coordinates into 2d cartesian coordinates. These mapping functions create produces a circular image where every x and y value pair can be mapped back to spherical coordinates. The functions map the angle from the optical axis (theta) to the distance of a point from the image circle center (r). For every point the angle around the optical axis (phi) stays the same in spherical coordinates and in the mapped image circle. The relation between x and y coordinates and the r and phi in the mapped image circle is the following: x=x0+r*cos(phi), y=y0+r*sin(phi), where the point (x0,y0) is the center of the image circle.

An example of such mapping function is equisolid which is commonly used in fisheye lenses. The equisolid mapping depends on the focal length (f) of the lens and is the following: r=2*f*sin(theta/2). So for a point that's in the center of the optical axis (theta is 0), r becomes zero and thus the mapped point is also in center of the image circle. For a point that's on a vector perpendicular to the optical axis (theta is 90 degrees), r becomes 1.41*f and the point in the image circle can be calculated as follows: x=x0+1.41*f*cos(phi), y=y0+1.41*f*sin(phi). The x and y can be scaled with constant multipliers to convert the coordinates to pixels in the target resolution. Other mapping functions may be stereographic (r=2*f*tan(theta/2)), equidistant (r=f*theta) and orthographic (r=f*sin(theta)).

Each layer may be fully (that is, without holes, in a continuous way) covering space around the camera, such as RENDER LAYER 1 in FIG. 4a, or it may be sparsely covering space with uncovered parts either totally left out using mapping parameters, or encoded as highly compressible zero values in a larger size, such as RENDER LAYER 2 in FIG. 4a. All objects that may be visualised are recorded in one of the layers. Each layer is supplied with the needed mapping parameters for mapping the two-dimensional image data of a layer into the render space. All layers may be finally packed into a single data structure supplied along with the necessary mapping metadata to decode them. Alternatively, the different layers may be provided in different files or streams, or different data structures.

In addition, the encoding of the layers may allow for scaling of rendering complexity, or reducing delivered data quantity, while still giving good reproduction of the scene. One approach to this is to pack all layers into a 2D image with increasingly distant sub layers located further along one axis, for example along the increasing y axis (down). When less rendering is required, the lower data is simply not delivered, or not decoded/processed, with only the top layer and possibly a limited sub-set of the sub-layers

The invention may allow recording, distribution and reproduction of an complex 3D environment with a level of physically realistic behaviour that has not previously been possible other than with a large data processing capacity rendering a fully synthetic scene. This may improve earlier reproduction techniques based on multiple images from different viewpoints by greatly reducing the amount of data that needs to be delivered for a particular image resolution due to the use of the render layer structures.

In FIG. 4b the forming of two render layers RENDER LAYER 1 and RENDER LAYER 2 using two cameras CAMR and CAML is illustrated. The different cameras “see” a different part of the object REAROBJ, because the object REAROBJ is hidden behind another object FRONTOBJ. The left camera CAML is able to capture more image information of the object REAROBJ from the left and the right camera CAMR from the right. When the render layers are created, for example by holding the point VIEWPNT as viewpoint, the FRONTOBJ object hides parts of the object REAROBJ for which there is image information, as well as a part for which there is no image information. Consequently, the first render layer RENDER LAYER 1 comprises pixels AREA1 that represent the first object FRONTOBJ and pixels AREA2 that represent the visible part of the second object REAROBJ. The second render layer comprises pixels AREA3 that correspond to the image information of the hidden parts of the second object REAROBJ. The pixels outside AREA3 may be empty, or dummy pixels. Depth information for the render layers may be created as explained earlier.

FIG. 4c illustrates rendering images using render layers. To render a stereo image or a stereo video sequence, image frames for the left and the right eye are formed, as explained earlier. For rendering an image frame, content from all layers RENDER LAYER1, RENDER LAYER2 is projected into one new rendering camera space and sorted by depth to render a correct scene. For example with a conventional graphics processing unit, each render layer point RP1, RP2, . . . , RPN and RPX1, RPX2, . . . may be treated as a “particle” and transformed using a vertex shader program and transformed into 3D render space with a single pixel “point sprite” including a depth value relative to the rendering viewpoint. The depth values for overlapping projected particles are compared and drawn in the correct order with the correct blending functions. This is illustrated by the dashed rectangles corresponding to the points RP1, RP2, RP3, RPX1, RPX2. In such a manner, pixels can be made to be located at places corresponding to the locations of their respective source image points in real space. Opaque content is rendered such that the nearest point to the rendering camera is shown. Non opaque content may be rendered with correct blending of content visible behind it.

It needs to be noticed here that a pixel of a render layer may in the render space represent a different size of an object. A pixel that is far away from the viewpoint (has a large depth value) may represent a larger object than a pixel closer to the viewpoint. This is because the render layer pixels may originally represent a certain spatial “cone” and the image content in that “cone”. Depending on how far the bottom of the cone is, the pixel represents a different size of a point in the space. The render layers may be aligned for rendering in such a manner that the pixel grids are essentially in alignment on top of each other when viewed from the render viewpoint.

For transforming the render layers to render space, they may need to be rotated. An example of a rotational transformation Rₓ of coordinates around the x-axis by an angle γ (also known as pitch angle) is defined by a rotational matrix

$${R}_{x} = ( \begin{matrix}1 & 0 & 0 \\ 0 & cos γ & - sin γ \\ 0 & sin γ & cos γ\end{matrix} ) .$$

In a similar manner rotations R_{y} (for yaw) and R_{z} (for roll) around the different axes can be formed. As a general rotation, a matrix multiplication of the three rotations by R=Rₓ R_{y} R_{z} can be formed. This rotation matrix can then be used to multiply any vector in a first coordinate system according to v₂=R v₁ to obtain the vector in the destination coordinate system.

As an example of rotations, when the user turns his head (there is rotation represented by pitch, yaw and roll values), the head orientation of the user may be determined to obtain a new head orientation. This may happen e.g. so that there is a head movement detector in the head-mounted display. When the new head orientation has been determined, the orientation of the view and the location of the virtual eyes may be recomputed so that the rendered images match the new head orientation.

As another example, a correction of a head-mounted camera orientation is explained. A technique used here is to record the capture device orientation and use the orientation information to correct the orientation of the view presented to user—effectively cancelling out the rotation of the capture device during playback—so that the user is in control of the viewing direction, not the capture device. If the viewer instead wishes to experience the original motion of the capture device, the correction may be disabled. If the viewer wishes to experience a less extreme version of the original motion—the correction can be applied dynamically with a filter so that the original motion is followed but more slowly or with smaller deviations from the normal orientation.

For a frame to be displayed, layers can be rendered in multiple render passes, starting from opaque layers and ending with layers containing semitransparent areas. Finally a separate post-processing render pass can be done to interpolate values for empty pixels if needed.

During rendering, the graphics processing (such as OpenGL) depth test is enabled to discard occluded fragments and depth buffer is enabled for writing. A1pha blending is enabled during rendering if rendered layer contains semitransparent areas, otherwise it is disabled. The scene geometry contains a large number of unconnected vertices (GL_POINT) which each correspond to one pixel in the stored render layer data. Depending on the layer storage format, a vertex can have different number of attributes. Vertex attributes are e.g. position (x, y, z), colour, or a texture coordinate pointing to actual layer image data.

OpenGL vertex and fragment processing is explained next as an example. Other rendering technologies may also be used in a similar manner.

Vertex and fragment processing may be slightly different for different layer storage formats. Steps to process a layer stored in a uncompressed list format may be as follows (per vertex):

1. Initially all vertices are allocated and passed to vertex processing stage with their attributes including view angle, colour, and depth relative to common origin (the render viewpoint). If the processed layer has semitransparent content, vertices must be sorted according to their depth values.

2. (Yaw, pitch, depth) representation of the vertex is converted into 3d Cartesian vector (x, y, z).

3. Camera and world transformations are applied to the vertex by multiplying it with corresponding matrices.

4. Vertex colour attribute is passed to fragment processing stage.

5. Final vertex coordinate is written to the output variable (gl_Position)

6. At the fragment processing stage colour data received from vertex processing is written directly into the output variable (gl_FragColor)

The steps to process a layer stored in a compressed image format, that is, the render layers comprising pixels with pixel colour data and depth values, may be as follows (per vertex):

1. Initially all vertices are allocated evenly around the scene having same depth value.

2. If a vertex is not inside the viewer's current field of view, a transform function is applied in order to position it inside the current field of view. A purpose of this transform is to initially concentrate all available vertices into currently visible area.

Otherwise the pixel data that is represented by that vertex would be clipped out during rendering at the fragment processing stage. Avoiding clipping in this case improves rendering quality. Position transformation can be done in a way that vertices outside the field of view get distributed evenly inside the field of view. For example, if the field of view is horizontally from 0 degrees to 90 degrees, a vertex which is originally located horizontally at direction 91 degrees would then be transformed into a horizontal position at 1 degrees. Similarly, vertices from horizontal positions at 91 degrees to 180 degrees would be transformed into 1 to 90 degrees range horizontally. Vertical positions can be calculated in the same way. To avoid transformed vertices getting into precisely same position as other vertices that are already inside field of view, a small constant fraction (e.g. in this example case 0.25 pixels) can be added to vertex new position value.

3. Texture coordinate for vertex colour data is calculated from transformed vertex position and it is passed to fragment processing stage.

4. A depth value is fetched for the vertex using a texture lookup from a texture.

5. View angles for vertex are calculated using a mapping function.

6. (Yaw, pitch, depth) depth representation of the vertex is converted into Cartesian 3d vector (x, y, z).

7. Camera and world transformations are applied to the vertex by multiplying it with corresponding matrices.

8. Pixel resolution causes small rounding errors in the final vertex position, this can be taken into account by calculating (sub pixel) rounding error and passing it to the fragment processing stage.

9. Final vertex coordinate is written to the shader output variable (gl_Position)

10. At the fragment processing stage colour data is retrieved from colour texture using received texture coordinate and taking into account sub pixel rounding error value in order to interpolate a more suitable colour value using the surrounding points (this is not possible with the uncompressed list format). Colour value is then written into the output variable (gl_FragColor)

The source pixels may aligned during rendering in such a manner that a first pixel from a first render layer and a second pixel from a second render layer are registered on top of each other by adjusting their position in space by a sub-pixel amount. Depending on the storage format of the render layers, the vertices (pixels) may first be aligned to a kind of a virtual grid (steps 1 and 2, in “compressed” image format), or not. The vertices may finally aligned/positioned in the steps where the camera and world transformations are applied after fetching the correct depth and transforming & mapping the coordinates (step 7). It needs to be understood that alignment may happen in another phase, as well, or as a separate step of its own.

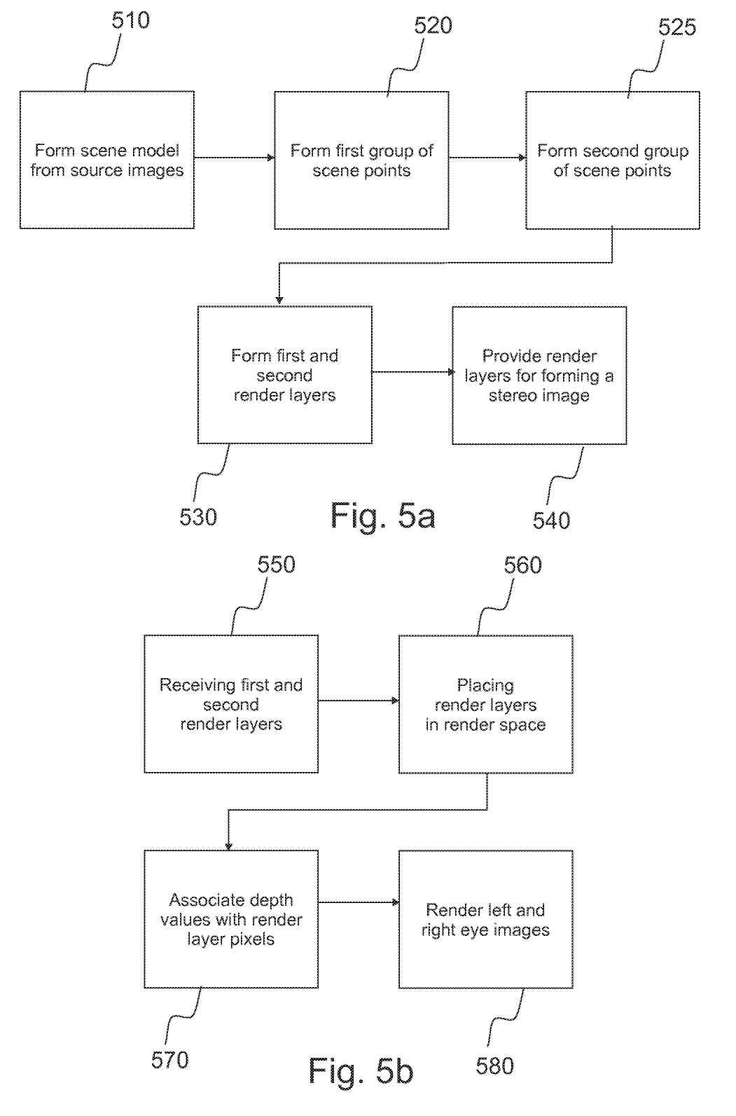

FIG. 5a is a flow chart of forming render layers by capturing image data. In phase 510, a scene model is formed using first image data from a first source image and second image data from a second source image. The scene model comprises scene points, and each scene point has a location in a coordinate space of the scene. This forming of the scene points from captured image data has been explained earlier. Alternatively or in addition, a synthetic scene may be used, wherein the synthetic scene comprises digital objects whose position, orientation, colour, transparency and other aspects are defined in the model. In phase 520, a first group of scene points is determined, the first group of scene points being visible from a render viewing point, the viewing point having a location in the scene coordinate space. That is, when the scene is being viewed from the render viewpoint (e.g. the centerpoint between the virtual eyes as explained in FIG. 1), the points that are visible (not obscured behind another object) from the viewpoint may belong to the first group of scene points. In phase 525, a second group of scene points is determined, the second group of scene points being at least partially obscured by the first group of scene points viewed from the render viewpoint. That is, the points of the second group are behind the points of the first group, or at least some of the points of the second group are obscured behind some of the points of the first group. In phase 530, a first render layer is formed using the first group of scene points and a second render layer is formed using the second group of scene points, the first and second render layer comprising pixels. In phase 540, the first and second render layers are provided for rendering a stereo image, for example by storing into a file or by transmitting them to a renderer. A stereo image may be computed from the render layers by computing a left eye image and a right eye image so that the two images are computed by having the virtual position of the left eye as a render viewpoint for the left eye image and the virtual position of the right eye as a render viewpoint for the right eye image.

A third group of scene points may also be determined, the third group of scene points being at least partially obscured by the second group of scene points viewed from the render viewing point. Then, a third render layer may be formed using the third group of scene points, the third render layer comprising pixels, and the third render layer may be provided for rendering a stereo image.

The second render layer may be a sparse layer comprising active pixels corresponding to scene points at least partially obstructed by the first group of scene points. Also, the third render layer may be a sparse layer. Because pixels may be “missing” in some sparse layers, dummy pixels may be formed in the second render layer, where the dummy pixels are not corresponding to any real scene points. This may be done to encode the second render layer into a data structure using an image encoder. The render layers may be into one or more encoded data structures using an image encoder, for the purpose of storing and/or transmitting the render layer data. For example, a file with a data structure comprising the render layers may be created. One or more of the render layers may be formed into a two-dimensional image data structure, the image data structure comprising render layer pixels. The render layer pixels may comprise color values and a transparency value such as an alpha value. Data of at least two of the render layers may be formed into a collated image data structure, as explained earlier, the collated image data structure comprising at least two segments, each segment corresponding to a respective render layer.

Forming the scene model may comprise determining a three-dimensional location for said scene points by utilizing depth information for said source images. Forming the scene model may comprise using camera position of said source images and comparing image contents of said source images, as has been explained earlier.

FIG. 5b is a flow chart of rendering images using render layers. In phase 550, a first render layer and a second render layer are received. The first and second render layer comprise pixels, and the first render layer comprises pixels corresponding to first parts of a scene viewed from a rendering viewpoint and the second render layer comprises pixels corresponding to second parts of the scene viewed from the rendering viewpoint. The second parts of the scene are obscured by the first parts viewed from the rendering viewpoint. In phase 560, pixels (or vertices) of the first render layer and pixels (or vertices) of the second render layer are placed in a rendering space. For example, if the render layers are stored as image data, the two-dimensional images may be transformed into the render space pixel by pixel. In phase 570, a depth value may be associated with the pixels, for example pixel by pixel. In phase 580, a left eye image and a right eye image may be rendered using the pixels and their depth values.

The pixels of the first render layer and the second render layer may comprise colour values and at least pixels of the first render layer may comprise transparency values such as alpha values for rendering transparency of at least pixels of the first render layer. To make this transparency processing more efficient, it may be determined whether a render layer to be rendered comprises semitransparent pixels, and in case the determining indicates that the render layer does comprise semitransparent pixels, alpha blending is enabled in rendering of the render layer, otherwise alpha blending is disabled in rendering the render layer.

The first render layer and the second render layer may be received from a data structure comprising pixel values as a two-dimensional image. For example, the render layers may be stored in image data format into an image file, or otherwise represented in a data structure (e.g. in the computer memory) in a two-dimensional format. The colour values for the pixels of the first and second render layers may be determined by using texture mapping by using the data in the data structure and mapping the colour values from the data structure to the rendering space with the help of texture processing capabilities of graphics rendering systems (like OpenGL graphics accelerators).

In a similar manner, the first render layer and the second render layer may be received from a data structure comprising pixel values as a two-dimensional image, and depth values for the pixels of the first and second render layers may be determined by using texture mapping, where the depth values indicate a distance from a rendering viewpoint. That is, the depth data may also be stored or transmitted in an image-like data structure corresponding to the colour values of the render layers.

For the purpose of rendering light reflections and shading, the render layers may comprise information of viewing angle values for the pixels of the render layer. The first render layer and the second render layer may be received from a data structure comprising pixel values as a two-dimensional image, and the viewing angle values may be determined from these pixel values for the pixels of the first and second render layers by using texture mapping. Such determining of the viewing angle values may, for example, happen by using a so-called “bump mapping” capability of a graphics processor. In such a method, the angle of orientation of pixels is calculated using a texture, and the reflection of light from light sources by pixels depends on this angle of orientation. In other words, for the purpose of computing the image to be displayed, the pixels may have a surface normal having another direction than towards the viewer.

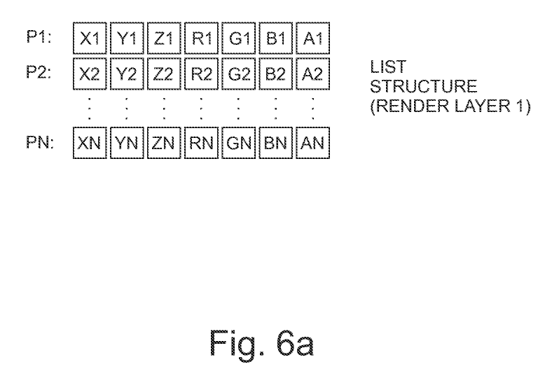

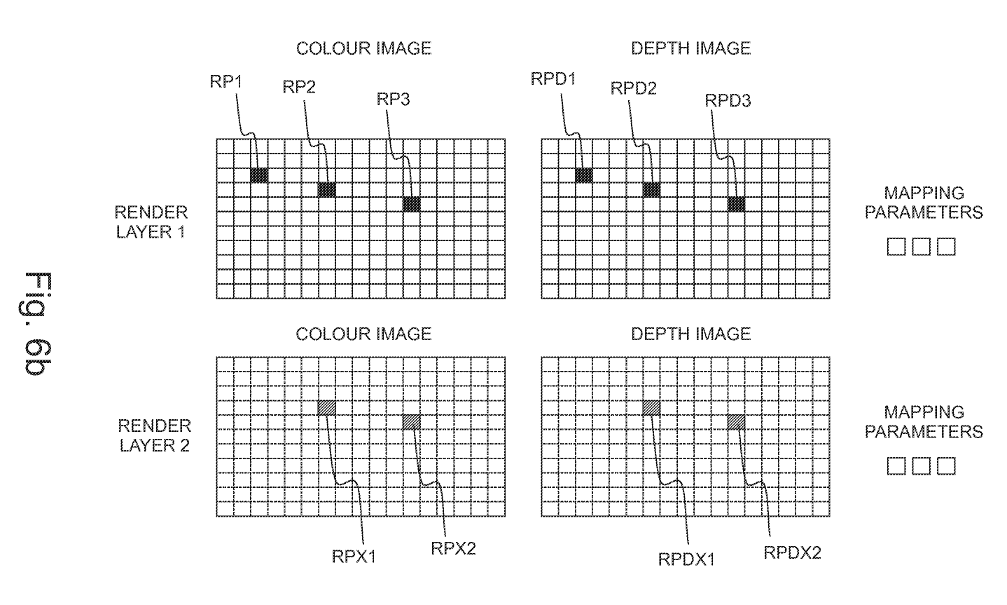

FIG. 6a depicts a data structure comprising render layers for rendering an image. In a non-compressed, list-type format, the various scene points are represented by point data structures each having values for colour (3 values, e.g. red, green, blue), transparency (e.g. alpha channel), position (3 values, e.g. yaw, pitch, depth coordinates) and possibly other attributes.

In FIG. 6b, in image data format, the colour values of scene points in the first render layer are represented by one coded image, the image comprising the colour values for the scene points as render layer pixels RP1, RP2, RP3, or the image comprising colour values that can be used to compute the colour values of the scene points e.g. by texture mapping. In a similar manner, other attributes of the first render layer may be represented as images, e.g. a depth value image comprising depth values RPD1, RPD2, RPD3 of the render layer pixels. The colour values of scene points in the second render layer are represented by one coded image, the image comprising the colour values for the scene points as render layer pixels RPX1, RPX2 or the image comprising colour values that can be used to compute the colour values of the scene points e.g. by texture mapping. Depth values RPDX1, RPDX2 are in the corresponding depth image.

The different render layers may have their own image data structures, or the render layers may be combined together to one or more images. For example, an image may have a segment for the first render layer data, another segment for the second render layer data, and so on. The image may be compressed using conventional image compression technologies.

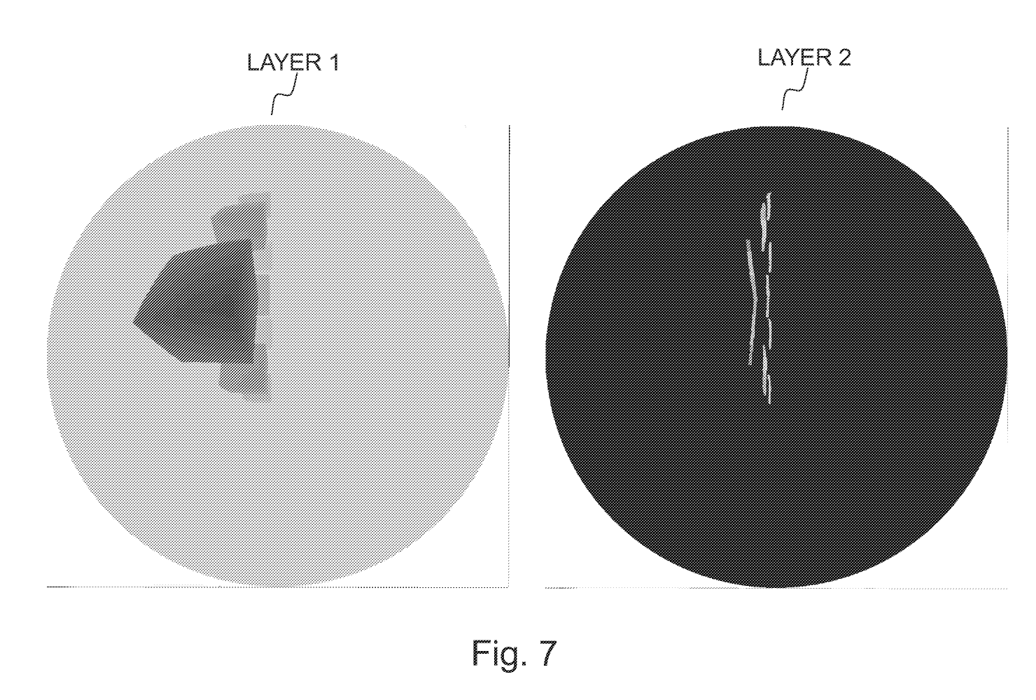

FIG. 7 shows an example of render layers. The first render layer LAYER 1 comprises an image of a number of cubes in a three-dimensional space. The cubes are so positioned that the cubes closer to the viewer obscure parts of cubes further away from the viewer. On the first layer, all the pixels comprise a color value, because in every direction, a part of the scene (at least the background) is visible. The second render layer LAYER 2 comprises some obscured parts of the cubes. The obscured parts have been obtained by taking an image from a slightly different viewpoint (to the left) from that of the first render layer. The second render layer does not comprise pixels that are available on the first render layer. Therefore, the second render layer is sparse, and many—in this case the most—pixels are empty (shown in black). Left and right eye images may be formed by using the pixel data from both render layers and computing the images for left and right eye, as explained earlier.

The various embodiments of the invention may be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1-68. (canceled)

69. A method, comprising:
forming a scene model using first image data from a first source image and second image data from a second source image, said scene model comprising scene points, each scene point having a location in a coordinate space of said scene;
determining a first group of scene points, said first group of scene points being visible from a viewing point, said viewing point having a location in said coordinate space of said scene;
determining a second group of scene points, said second group of scene points being at least partially obscured by said first group of scene points viewed from said viewing point;
forming a first render layer using said first group of scene points and a second render layer using said second group of scene points, said first and second render layer comprising pixels; and
providing said first and second render layers for rendering a stereo image.

70. The method according to claim 69, further comprising:
determining a third group of scene points, said third group of scene points being at least partially obstructed by said second group of scene points viewed from said viewing point;
forming a third render layer using said third group of scene points, said third render layer comprising pixels; and
providing said third render layer for rendering a stereo image.

71. The method according to claim 69, wherein said second render layer is a sparse layer comprising active pixels corresponding to scene points at least partially obstructed by said first group of scene points.

72. The method according to claim 71, further comprising:
forming dummy pixels in said second render layer, said dummy pixels not corresponding to scene points; and
encoding said second render layer into a data structure using an image encoder.

73. The method according to claim 69, wherein forming said scene model comprises at least one of the following:
determining a three-dimensional location for said scene points by utilizing depth information for said source images; and
using camera position of said source images and comparing image contents of said source images.

74. The method according to claim 69, further comprising:
forming one or more of said render layers to a two-dimensional image data structure, said image data structure comprising render layer pixels.

75. The method according to claim 74, wherein render layer pixels comprise color values and a transparency value such as an alpha value.

76. The method according to claim 69, further comprising:
forming data of at least two of said render layers into a collated image data structure, said collated image data structure comprising at least two segments, each segment corresponding to a respective render layer.

77. A method comprising:
receiving a first render layer and a second render layer, said first and second render layer comprising pixels, said first render layer comprising pixels corresponding to first parts of a scene viewed from a rendering viewpoint and said second render layer comprising pixels corresponding to second parts of said scene viewed from said rendering viewpoint, wherein said second parts of said scene are obscured by said first parts viewed from said rendering viewpoint;
placing pixels of said first render layer and pixels of said second render layer in a rendering space;
associating depth values with said pixels; and
rendering a left eye image and a right eye image using said pixels and said depth values.

78. The method according to claim 77, wherein said pixels of said first render layer and said second render layer comprise colour values and at least pixels of said first render layer comprise transparency values such as alpha values for rendering transparency of at least pixels of said first render layer.

79. The method according to claim 77, comprising:
determining whether a render layer to be rendered comprises semitransparent pixels; and
in case said determining indicates a render layer comprises semitransparent pixels, enabling alpha blending in rendering of said render layer, otherwise disabling alpha blending in rendering said render layer.

80. The method according to claim 77, comprising:
receiving said first render layer and said second render layer from a data structure comprising pixel values as a two-dimensional image; and
determining colour values for said pixels of said first and second render layers by using texture mapping.

81. The method according to claim 77, comprising:
receiving said first render layer and said second render layer from a data structure comprising pixel values as a two-dimensional image; and
determining depth values for said pixels of said first and second render layers by using texture mapping, said depth values indicating a distance from a rendering viewpoint.

82. The method according to claim 77, comprising:
receiving said first render layer and said second render layer from a data structure comprising pixel values as a two-dimensional image; and
determining viewing angle values for said pixels of said first and second render layers by using texture mapping.

83. An apparatus comprising at least one processor, memory including computer program code, the memory and the computer program code configured to, with the at least one processor, cause the apparatus to perform at least the following:
form a scene model using first image data from a first source image and second image data from a second source image, said scene model comprising scene points, each scene point having a location in a coordinate space of said scene;
determine a first group of scene points, said first group of scene points being visible from a viewing point, said viewing point having a location in said coordinate space of said scene;
determine a second group of scene points, said second group of scene points being at least partially obscured by said first group of scene points viewed from said viewing point;
form a first render layer using said first group of scene points and a second render layer using said second group of scene points, said first and second render layer comprising pixels; and
provide said first and second render layers for rendering a stereo image.

84. The apparatus according to claim 83, wherein the memory and the computer program code configured to, with the at least one processor, further cause the apparatus to perform at least the following:
determine a third group of scene points, said third group of scene points being at least partially obstructed by said second group of scene points viewed from said viewing point;
form a third render layer using said third group of scene points, said third render layer comprising pixels; and
provide said third render layer for rendering a stereo image.

85. The apparatus according to claim 83, wherein said second render layer is a sparse layer comprising active pixels corresponding to scene points at least partially obstructed by said first group of scene points.

86. The apparatus according to claim 85, wherein the memory and the computer program code configured to, with the at least one processor, further cause the apparatus to perform at least the following:
form dummy pixels in said second render layer, said dummy pixels not corresponding to scene points; and
encode said second render layer into a data structure using an image encoder.

87. The apparatus according to claim 83, wherein forming said scene model comprises at least of the following:
determining a three-dimensional location for said scene points by utilizing depth information for said source images; and
using camera position of said source images and comparing image contents of said source images.

88. The apparatus according to claim 83, wherein the memory and the computer program code configured to, with the at least one processor, further cause the apparatus to perform at least the following:
form one or more of said render layers to a two-dimensional image data structure, said image data structure comprising render layer pixels.

89. The apparatus according to claim 88, wherein render layer pixels comprise color values and a transparency value such as an alpha value.

90. The apparatus according to claim 83, wherein the memory and the computer program code configured to, with the at least one processor, further cause the apparatus to perform at least the following:
form data of at least two of said render layers into a collated image data structure, said collated image data structure comprising at least two segments, each segment corresponding to a respective render layer.

91. An apparatus comprising at least one processor, memory including computer program code, the memory and the computer program code configured to, with the at least one processor, cause the apparatus to perform at least the following:
receive a first render layer and a second render layer, said first and second render layer comprising pixels, said first render layer comprising pixels corresponding to first parts of a scene viewed from a rendering viewpoint and said second render layer comprising pixels corresponding to second parts of said scene viewed from said rendering viewpoint, wherein said second parts of said scene are obscured by said first parts viewed from said rendering viewpoint;
place pixels of said first render layer and pixels of said second render layer in a rendering space;
associate depth values with said pixels; and
render a left eye image and a right eye image using said pixels and said depth values.

92. The apparatus according to claim 91, wherein said pixels of said first render layer and said second render layer comprise colour values and at least pixels of said first render layer comprise transparency values such as alpha values for rendering transparency of at least pixels of said first render layer.

93. The apparatus according to claim 91, wherein the memory and the computer program code configured to, with the at least one processor, further cause the apparatus to perform at least the following:
determine whether a render layer to be rendered comprises semitransparent pixels; and
in case said determining indicates a render layer comprises semitransparent pixels, enable alpha blending in rendering of said render layer, otherwise disabling alpha blending in rendering said render layer.

94. An apparatus according to claim 91, wherein the memory and the computer program code configured to, with the at least one processor, further cause the apparatus to perform at least the following:
receive said first render layer and said second render layer from a data structure comprising pixel values as a two-dimensional image; and
determine colour values for said pixels of said first and second render layers by using texture mapping.

95. The apparatus according to claim 91, wherein the memory and the computer program code configured to, with the at least one processor, further cause the apparatus to perform at least the following:
receive said first render layer and said second render layer from a data structure comprising pixel values as a two-dimensional image; and
determine depth values for said pixels of said first and second render layers by using texture mapping, said depth values indicating a distance from a rendering viewpoint.

96. The apparatus according to claim 91, wherein the memory and the computer program code configured to, with the at least one processor, further cause the apparatus to perform at least the following:
receive said first render layer and said second render layer from a data structure comprising pixel values as a two-dimensional image; and
determine viewing angle values for said pixels of said first and second render layers by using texture mapping.
